(19) United States
(12) Patent Application Publication
(10) Pub. No.: US 2010/0156917 A1
(43) Pub. Date: Jun. 24, 2010

(54) IMAGE PROCESSING APPARATUS AND METHOD FOR MANAGING FRAME MEMORY IN IMAGE PROCESSING

(75) Inventors: Hoo Sung LEE, Daejeon (KR); Kyoung Seon Shin, Daejeon (KR); Ig Kyun Kim, Daejeon (KR); Suk Ho Lee, Daejeon (KR); Sang Heon Lee, Daejeon (KR); Seong Mo Park, Daejeon (KR); Nak Woong Eum, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/579,630

(22) Filed: Oct. 15, 2009

(30) Foreign Application Priority Data
Dec. 22, 2008 (KR) 10-2008-0131607

(51) Int. Cl. G06F 12/02; G06F 12/00

(52) U.S. Cl. 345/543; 711/157; 711/E12.001

(57) ABSTRACT

A method for managing a frame memory includes: determining a frame memory structure with reference to memory configuration information and image processing information; configuring a frame memory such that a plurality of image signals are stored in each page according to the frame memory structure; and computing a signal storage address by combining image acquiring information by bits, and accessing a frame memory map to write or read an image signal by pages.

### CROSS-REFERENCE TO RELATED APPLICATIONS

This application claims the priority of Korean Patent Application No. 10-2008-0131607 filed on Dec. 22, 2008, in the Korean Intellectual Property Office, the disclosure of which is incorporated herein by reference.

### BACKGROUND OF THE INVENTION

1. Field of the Invention

The present application relates to a technique that effectively manages frame memory in an image processing apparatus that accesses the frame memory by blocks (i.e., in units of blocks) and, more particularly, to an image processing apparatus, which uses a DRAM (embedded DRAM, SDR, and DDR SDRAM, etc.) as a frame memory, capable of using an overall bandwidth provided by the frame memory without a loss, and a method for managing the frame memory for image processing.

2. Description of the Related Art

Recently, due to the development of networks, improved storage capacities and effective displays, the amount of multimedia data is rapidly increasing. In case of video (i.e., moving pictures, moving images, etc.), conventionally, video with SD grade resolution (480p) was the mainstream, but currently, Full-HD video with a resolution of (1080p) and video beyond the HD grade (720p) is being generalized.

Full HD video has resolution of 1920×1080. However, because it is internally processed as 1920×1088, namely, a multiple of macroblocks (16×16), a frame memory to store 1920×1088 pixels is required.

In the case of storing data in the YCbCr 4:2:0 format, which is commonly used in image compression or decompression because the amount of data per frame is the smallest, a frame memory of about 24 Mbits per frame is required, and for video compression or decompression, at least two or more frame memories including one or more sheets of reference memory and one sheet of reconfiguration memory are required. That is, the use of an external memory is requisite.

Currently, a dynamic random access memory (DRAM) having a smaller area and being lower-priced than a static random access memory (SRAM) is used as the frame memory.

Here, a detailed description of the DRAM used as the frame memory will be omitted. In general, the DRAM includes two or more banks, and each bank is constructed by rows and columns. A memory unit having the same row address is called a page. In case of a single memory, memories having a page size of 1024 bytes or 2048 bytes are manufactured, and in case of a module type memory formed by combining single memories, modular memories having a page size of 4096 bytes or larger are manufactured according to configurations. Continuous accessing is possibly performed without delay in a single page, but accessing a different page needs delay for a precharge.

As for the delay, if frame data is stored by using two or more banks and the banks are accessed by turns, or if a DRAM access command is accessed in an overlap manner, the delay may be concealed.

In case of an H.264/AVC image codec having the best compression efficiency so far, the macroblock of 16×16 pixel size is defined and processing and data accessing are performed by macroblocks.

Besides the H.264/AVC, most of the currently used video codecs define macroblocks and process compression and decompression based on the macroblocks.

Image processing devices mostly have an interface for their connection to an image inputting and outputting device, and image inputting/outputting devices mostly have a structure in which data is inputted or outputted in the raster scan order.

FIG. 1 illustrates the configuration of a screen image by macroblocks displaying a Full HD image using the H.264/AVC standard.

The Full HD image includes a total of 8,160 macroblocks (120 in width×68 in length, and each macroblock includes 16×16 pixels), and is stored in the frame memory according to various methods as shown in FIGS. 2A to 2C.

Among the methods, a method of storing the Full HD image while increasing addresses according to the scanning order as shown in FIG. 2A, and a method in which data is stored while increasing column addresses of DRAM in the scanning order, and when a scan line changes, one row address is increased, and storing data is resumed while increasing the column addresses as shown in FIG. 2B have been commonly used for the frame memory.

The method as shown in FIG. 2A is advantageous in that the memory can be effectively used but disadvantageous in that a multiplier is required for address computation (calculation), thus it is not intuitive.

With the method as shown in FIG. 2B, there is a waste in the memory, but because the X coordinates of the pixels are consistent with the column addresses and Y coordinates of the pixels are consistent with the row addresses, the address computation is simple and intuitive, and thus, this method is frequently employed.

The methods as shown in FIGS. 2A and 2B are appropriate for accessing the frame memory in units of scan lines when a screen image to be compressed is input or a decompressed screen image is displayed. However, in compressing or decompressing a screen image, because memory is accessed by blocks, in order to access one block, the row address should be changed at each display line of the screen image, causing a further delay for changing column addresses. Therefore these methods are inappropriate for an image processing device.

For example, when a DRAM, which includes pixels, each having 8 bits, stored therein, has a 6-clock delay time required for a row address conversion, and has a 32-bit interface, is used as a frame memory, a luminance (LUMA) macroblock having a pixel size of 16×16 used in H.264/AVC may be accessed as follows.

Because 16 row address changes must be performed to access the macroblock, a delay time of 96 (6×16) clocks is required. Also, because the data of 4 pixels (4×8 bits) is output at one clock, a total of 64 clocks (16/4×16) is taken to output the data of the 16×16 macroblock. That is, in order to access the macroblock, a total of 160 clocks including the delay and data transmission time are used, which accounts for about 40% of the bandwidth the DRAM can offer.

In the H.264/AVC, for motion compensation of a chrominance signal (i.e., chroma signal) of a 4×4 block, a 3×3 block must be accessed.

Thus, in an effort to solve the problem, a method of sequentially storing each macroblock in a single column address of a frame memory and performing accessing by macroblocks has been proposed, as shown in FIG. 2C. However, this method has shortcomings in that address computation is complicated, performance is degraded in accessing a block at the boundary of a macroblock, and data realignment is required for a screen image display.

In order to solve the degradation of performance in accessing the block at the boundary of the macroblock, a frame memory structure allowing a multi-bank interleaving by storing an adjacent macroblock in a different bank or dividing one macroblock into several partitions and storing an adjacent partition in a different bank has been proposed. However, this frame memory structure also makes the address computation more complicated and still requires the data realignment for a screen image display.

### SUMMARY OF THE INVENTION

An aspect of the present application provides a method and apparatus for managing a frame memory capable of removing the necessity of realignment of frame data for a screen image display, simplifying an address computation in accessing the frame memory by blocks, having an intuitive memory structure, and successively accessing block data without delay.

Another aspect of the present application provides a method and apparatus for managing a frame memory capable of accessing the frame memory by selecting a frames/field by macroblocks to effectively support interlace scanning.

Another aspect of the present application provides a method and apparatus for managing a frame memory capable of automatically generating a frame memory structure suitable for a configuration with reference to settings of an image processing device and an external memory.

Another aspect of the present application provides a method and apparatus for managing a frame memory capable of facilitating management by integrating frame memory-related functions which have been generally distributed to be managed.

According to an aspect of the present invention, there is provided a method for managing a frame memory, including: determining a frame memory structure with reference to memory configuration information and image processing information; configuring a frame memory such that a plurality of image signals can be stored in each page according to the frame memory structure; and computing signal storage addresses by combining image acquiring information by bits, and accessing a frame memory map to write or read an image signal by pages.

In determining the frame memory structure, the maximum number of frames of the frame memory, the number of image lines per page, a frame offset, and a chrominance signal offset may be determined with reference to the memory configuration information including information about a page size, a bus width, the number of banks, and the number or rows, and the image processing information including information about a width and height of an image.

In determining the frame memory structure, the maximum number of frames and the number of image lines per page may be determined by the equations shown below:

Image width=pixel width of a macroblock unit×16 1)

Image height=pixel height of a macroblock unit×16 2)

Frame access line distance=2^{(Ceil(log}^{₂}^{(image width)))} 3)

Field access line distance=frame access line distance×2 4)

Number of image lines per page=page size/frame access line distance 5)

Maximum number of frames=floor(number of memory rows/frame offset) 6)

In determining the frame memory structure, the chrominance signal offset may be determined to be image height/image lines per page/number of banks (namely, chrominance signal offset=image height/image lines per page/number of banks) or may be input by a user, and the frame offset may be determined by multiplying 3/2 to chrominance signal offset (frame offset=chrominance offset×3/2), or may be inputted by a user.

In configuring the frame memory, the number of frames may be determined according to the maximum number of frames, a single bank may be divided into a plurality of subbanks according to the number of image lines per page, and a luminance signal and a chrominance signal may be separately stored according to the frame offset and the chrominance signal offset.

In configuring the frame memory, when an image signal includes a luminance signal and first and second chrominance signals, a start address of rows for storing the luminance signal may be determined according to the frame offset, and a start address of rows for storing the first and second chrominance signals may be determined according to the frame offset and the chrominance signal offset.

In configuring the frame memory, when an image signal includes a luminance signal and first and second chrominance signals, a plurality of luminance signals or the first and second chrominance signals may be stored together in a single page.

In writing and reading, when an image signal includes a luminance signal and first and second chrominance signals and a frame offset is 2n, a luminance signal address and first and second chrominance signal addresses may be acquired from image acquisition information including a frame index, a signal type, and x and Y coordinates according to following equations: 1) a luminance pixel address={frame index, luminance pixel, Y coordinate, X coordinate}={row address, bank address, column address, byte address}, 2) first chrominance pixel address={frame index, chrominance pixel, Y coordinate, X coordinate, a chrominance pixel type}={row address, bank address, column address, byte address}, and 3) second chrominance pixel address=first chrominance pixel address+1.

In writing and reading, when an image signal includes a luminance signal and first and second chrominance signals and a frame offset is not 2n, a luminance signal address and first and second chrominance signal addresses may be acquired from image acquisition information including a frame index, a signal type, and x and Y coordinates, according to following equations: 1) a luminance pixel address=frame index×frame offset+{Y coordinate, X coordinate}={row address, bank address, column address, byte address}, 2) first chrominance pixel address=frame index×frame offset+chrominance offset+{Y coordinate>>1, X coordinate>>1, a chrominance pixel type}={row address, bank address, column address, byte address}, and 3) second chrominance pixel address=first chrominance pixel address+1.

In writing and reading, accessing is performed in a bank interleaving manner, and in this case, an access unit may be changed by correcting a line distance, and a field access line distance may be double a frame access line distance.

According to another aspect of the present invention, there is provided an apparatus for managing a frame memory, including: a stream controller that interprets an image data stream provided from a host system; a stream processing unit that reads an image signal of a region corresponding to a motion vector provided from the stream controller, from a frame memory to configure a motion compensation screen image, and configures a predicted screen image and a residual screen image based on data provided from the stream controller; a screen image reconfiguring unit that configures an original screen image by adding the predicted screen image or the motion compensation screen image and the residual screen image in a screen image; a deblocking filter that reads a screen image of a neighbor block from the frame memory, filters the read screen image together with the original screen image, and restores the same in the frame memory; and a frame memory controller that provides control to simultaneously store a plurality of image signals in each page of the frame memory, and acquires a signal storage address from image acquisition information through a bit unit combining method and accesses the frame memory to write or read an image signal by pages when the stream processing unit or the deblocking filter requests accessing.

The frame memory controller may determine the maximum number of frames of the frame memory, the number of image lines per page, a frame offset, and a chrominance signal offset with reference to the memory configuration information including information about a page size, a bus width, the number of banks, and the number or rows, and the image processing information including information about a width and height of an image.

The frame memory controller may determine the number of frames according to the maximum number of frames, divides a single bank into a plurality of subbanks according to the number of image lines per page, and separately stores a luminance signal and a chrominance signal according to a frame offset and a chrominance signal offset.

When an image signal includes a luminance signal and first and second chrominance signals and a frame offset is 2n, the frame memory controller may acquire a luminance signal address and first and second chrominance signal addresses from image acquisition information including a frame index, a signal type and x and Y coordinates, such that 1) a luminance pixel address={frame index, luminance pixel, Y coordinate, X coordinate}={row address, bank address, column address, byte address}, 2) first chrominance pixel address={frame index, chrominance pixel, Y coordinate, X coordinate, a chrominance pixel type}={row address, bank address, column address, byte address}, and 3) second chrominance pixel address=first chrominance pixel address+1.

When an image signal includes a luminance signal and first and second chrominance signals and a frame offset is not 2n, the frame memory controller may acquire a luminance signal address and first and second chrominance signal addresses from image acquisition information including a frame index, a signal type and x and Y coordinates, such that 1) a luminance pixel address=frame index x frame offset+{Y coordinate, X coordinate}={row address, bank address, column address, byte address}, 2) first chrominance pixel address=frame index x frame offset+chrominance offset+{Y coordinate>>1, X coordinate>>1, a chrominance pixel type}={row address, bank address, column address, byte address}, and 3) second chrominance pixel address=first chrominance pixel address+1.

The frame memory controller performs accessing in a bank interleaving manner, and in this case, an access unit may be changed by correcting a line distance, and a field access line distance may be double a frame access line distance.

### BRIEF DESCRIPTION OF THE DRAWINGS

The above and other aspects, features and other advantages of the present application will be more clearly understood from the following detailed description taken in conjunction with the accompanying drawings, in which:

FIG. 1 illustrates the configuration of a Full HD screen image used for H.264/AVC standard in units of macroblocks;

FIGS. 2A to 2C illustrate screen images for explaining the related art frame memory storage method;

FIG. 3 is a schematic block diagram of an image processing apparatus according to an exemplary embodiment of the present invention;

FIG. 4 illustrates locations of luminance and chrominance samples of a frame and top and bottom fields;

FIG. 5 illustrates an image block to be transmitted in a frame memory space with resolution of W×H;

FIG. 6 illustrates one-dimensional and two-dimensional memory transmission structures;

FIGS. 7A and 7B illustrate storage addresses and storage locations of macroblocks according to an exemplary embodiment of the present invention;

FIG. 8 illustrates a frame memory map according to an exemplary embodiment of the present invention;

FIGS. 9A and 9B illustrate the cycles of transmitting 9×9 pixels including neighbor pixels for computing intermediate pixels for motion compensation with respect to luminance 4×4 blocks in H.264/AVC;

FIGS. 10A and 10B illustrate the cycles of transmitting 3×3 pixels including neighbor pixels for computing intermediate pixels for motion compensation with respect to chrominance 4×4 blocks in H.264/AVC; and

FIG. 11 illustrates concealment of an initial delay six cycles generated during data transmission by previous data transmission cycles due to bank interleaving, when data blocks are continuously transmitted.

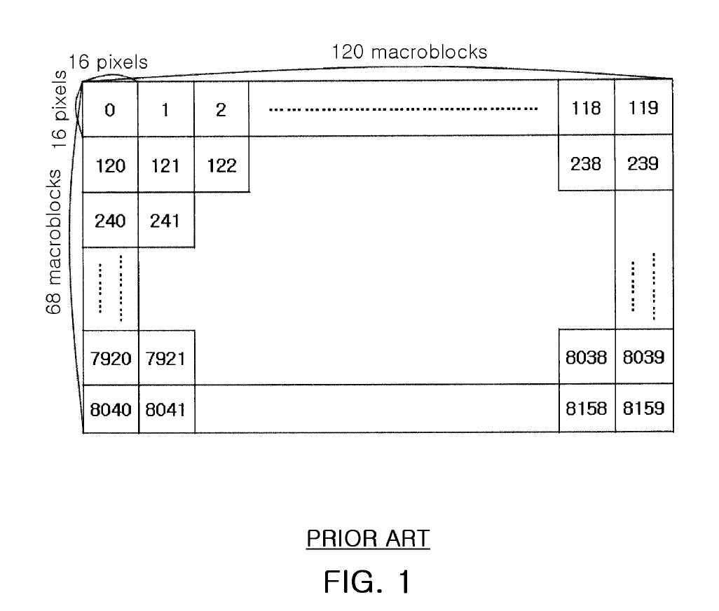

### DETAILED DESCRIPTION OF THE PREFERRED EMBODIMENT

Exemplary embodiments of the present application will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

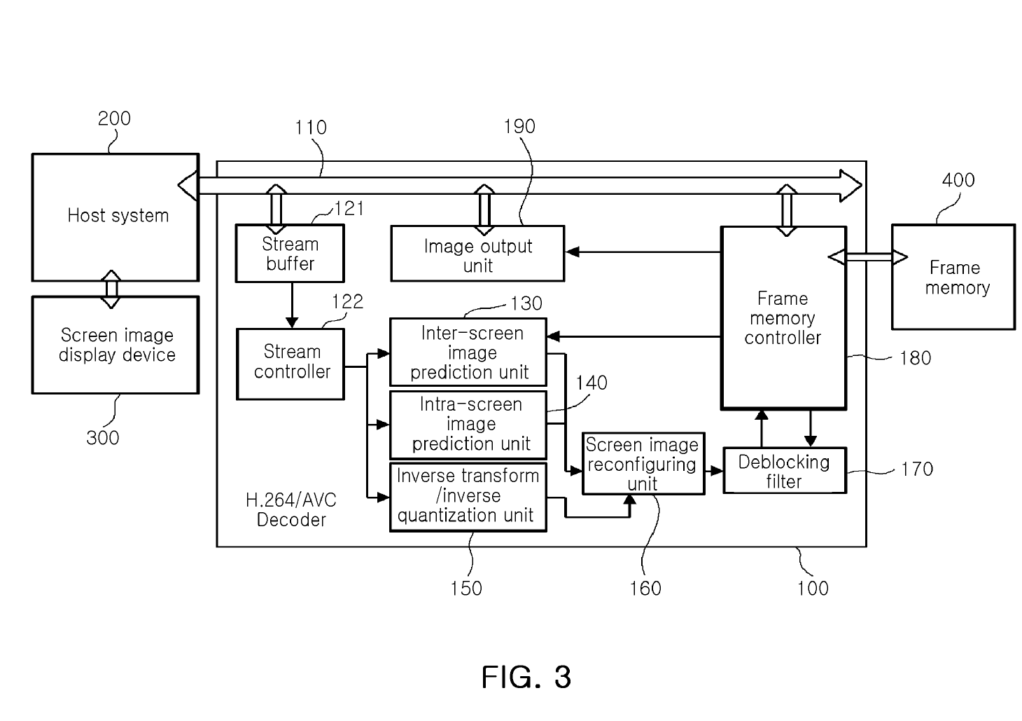

FIG. 3 is a schematic block diagram of an image processing apparatus according to an exemplary embodiment of the present invention.

With reference to FIG. 3, a decoder 100 according to an exemplary embodiment of the present application includes a host interface bus 110 connected to a host system 200, a stream buffer 121, a stream controller 122, an inter-screen image prediction unit 130, an intra-screen image prediction unit 140, an inverse transform/inverse quantization unit 150, a screen image reconfiguring unit 160, a deblocking filter 170, a frame memory controller 180, and an image output unit 190.

The host system 200, which includes a processor and peripheral devices in which an application program is executed, may be included in a codec device such as an H.264/AVC codec or may be an external system. A frame memory 400, a memory device having two or more banks, may be included in the codec device or may be an external memory. For example, if the frame memory 400 is included in the codec device, it may be implemented as an embedded DRAM, and if the frame memory 400 is mounted outside the codec device, it may be implemented as a single data rate (SDR) SDRAM or a dual data rate (DDR) SDRAM.

The functions of each element will now be described.

The host interface bus 110 transmits initialization information regarding each function module and an image data stream provided from the host system 200, or transmits an image data stream outputted from the image output unit 190 to the host system 200.

The stream buffer 121 acquires and buffers an image data stream transmitted from the host interface bus 110 and provides the image data stream to the stream controller 122. The stream controller 122 interprets the received image data stream and distributes the interpreted data to each module.

The inter-screen image prediction unit 130 reads data of a region corresponding to a motion vector received from the stream controller 122 from the frame memory 400 to configure a motion compensation screen image, and transmits the same to the screen reconfiguring unit 160.

The intra-screen image prediction unit 140 configures a predicted screen image based on data received from the stream controller 122, and transfers the configured image to the screen image reconfiguring unit 160.

The inverse transform/inverse quantization unit 150 configures a residual screen image based on data received from the stream controller 122 and transmits the configured residual screen image to the screen image reconfiguring unit 160.

The screen image reconfiguring unit 160 adds the predicted screen image or a motion compensation screen image and the residual screen image in a screen according to a mode to reconfigure an original screen image and transmits the reconfigured original screen image to the deblocking filter 170.

The deblocking filter 170 reads a screen image of neighbor blocks from the frame memory 400, performs filtering on the read screen image of the neighbor blocks together with the reconfigured screen image to remove a block distortion appearing at the boundary of the blocks, and stores the same in the frame memory 400.

When a request for reading operation is received from the inter-screen image prediction unit 130, the deblocking filter 170, or the image output unit 190, the frame memory controller 180 reads the corresponding data from the frame memory 400 and transmits it to a corresponding module, or when a request for writing operation is received from the deblocking filter 170, the frame memory controller 180 stores the corresponding data in the frame memory 400. In this case, data transmission with respect to the frame memory is made in units of blocks.

The image output unit 190 reads the screen image stored in the frame memory 400, converts the stored image into an RGB format, and transmits the converted RGB format to the host system 200.

The host system 200 displays the data received from the image output unit 190 on a screen image display device 300.

The H.264/AVC supports interlace scanning that scans pixel lines by dividing them into two fields (even number lines and odd number lines), and includes a picture-adaptive frame/field (AFF) coding scheme that selects a frame/field in units of pictures (i.e., by pictures) and a macroblock (MB)-AFF coding scheme that selects a frame/field in units of macroblocks (i.e., by macroblocks).

Thus, in order to effectively support the interlace scanning, when a field/frame is written in or read from the frame memory, the field/frame needs to be accessed by macroblocks.

As an image format used in H.264/AVC, a YCbCr4:2:0 format in which a chroma signal (i.e., chrominance signal) has resolution of 2/1 in width and length of a luma signal (i.e., luminance signal) is largely used.

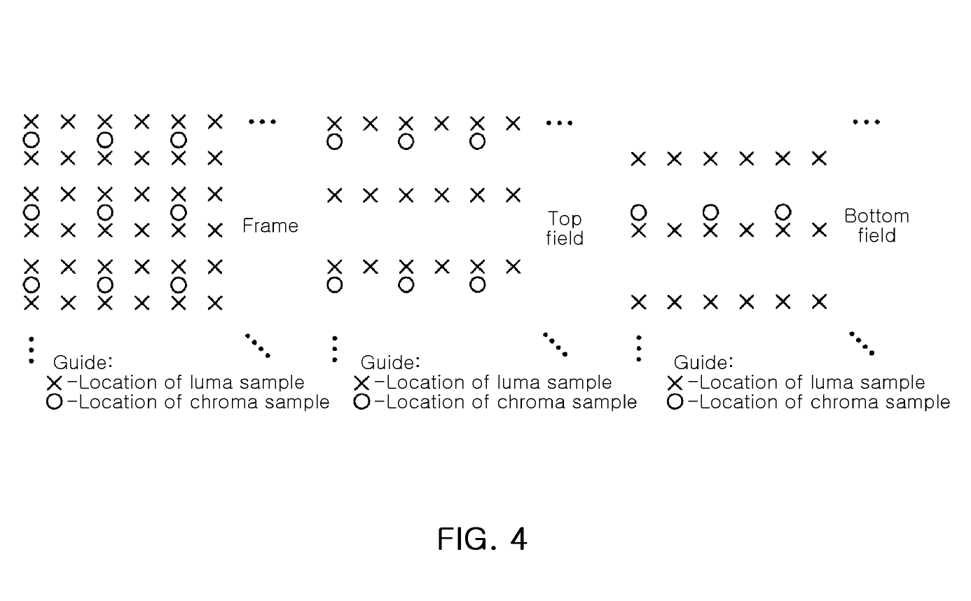

FIG. 4 illustrates locations of luma and chroma samples of a frame and top and bottom fields.

Y is the luma component, Cb is a blue-difference chroma component, and Cr is a red-difference chroma component. A single 16×16 macroblock includes a 16×16 luma signal, a 8×8 Cb signal, and a 8×8 Cr signal, which are independently processed.

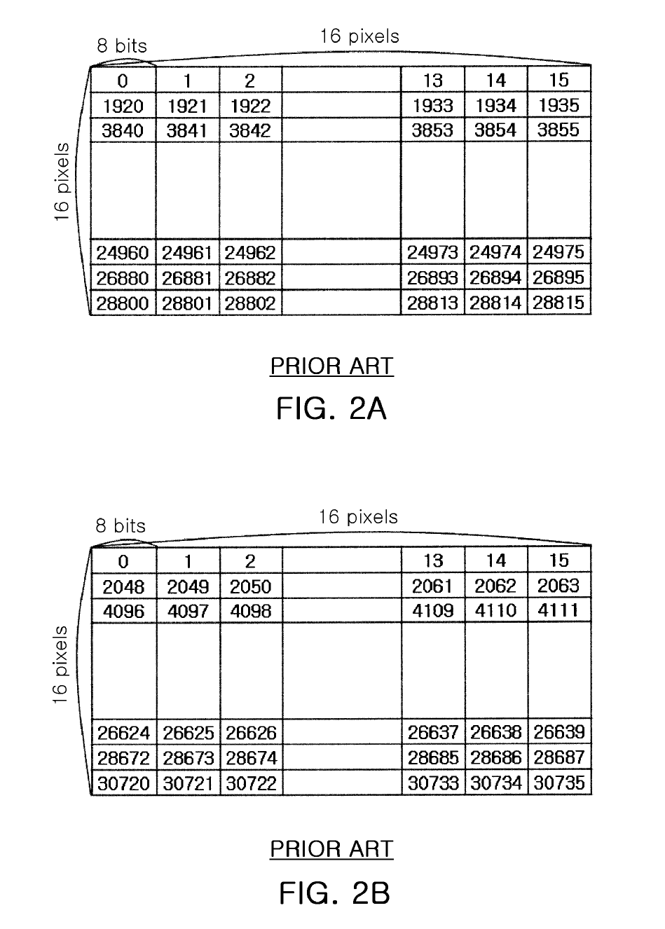

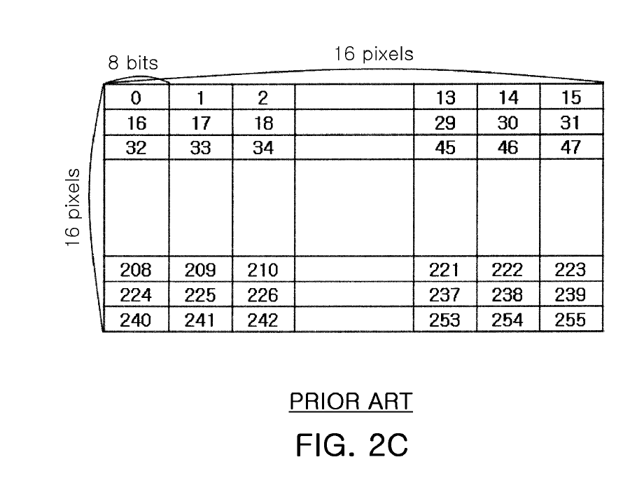

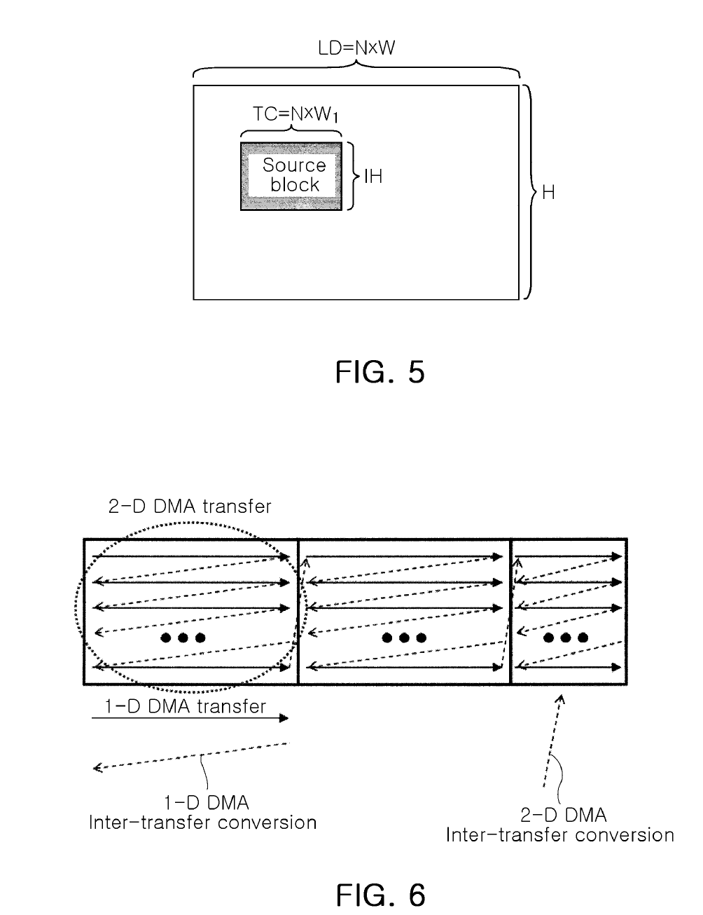

FIG. 5 illustrates an image block to be transmitted in a frame memory space with resolution of W×H. In this case, in order to simplify address computation as shown in FIG. 2B, an image width (W) is limited to 2n (n=1, 2, 3, in the frame memory space.

If an actual image width is not 2n, data from the actual image width to 2n is not used. If each pixel has N byte, the original image with the WH resolution is stored as a two-dimensional array having H number of NW bytes in the frame memory.

Thus, the interval between lines (or rows) constituting the original image is NW bytes, which is defined as a line distance (LD). If a horizontal resolution of a block to be transmitted is W1, the amount of data corresponding to one ling of the block to be transmitted is NW1 bytes, and vertical resolution of the block to be transmitted may be defined as an image height (IH).

Accordingly, the frame memory with the WH resolution in which each pixel has N bytes requires parameters N, W, W1, IH, and the like, to define an arbitrary image block with a W1×IH resolution.

FIG. 6 illustrates one-dimensional and two-dimensional memory transmission structures. A one-dimensional direct memory access (DMA) refers to transmission of data of burst length (BL) number having continuous addresses, and a two-dimensional DMA represents a repetitive one-dimensional DMA. The capacity transmitted by the one-dimensional DMA is calculated by multiplying BL to a data size, and a start address of each one-dimensional DMA has a regular interval.

In an exemplary embodiment of the present invention, a frame memory structure suitable for a configuration is automatically generated with reference to settings of an image processing device and an external memory.

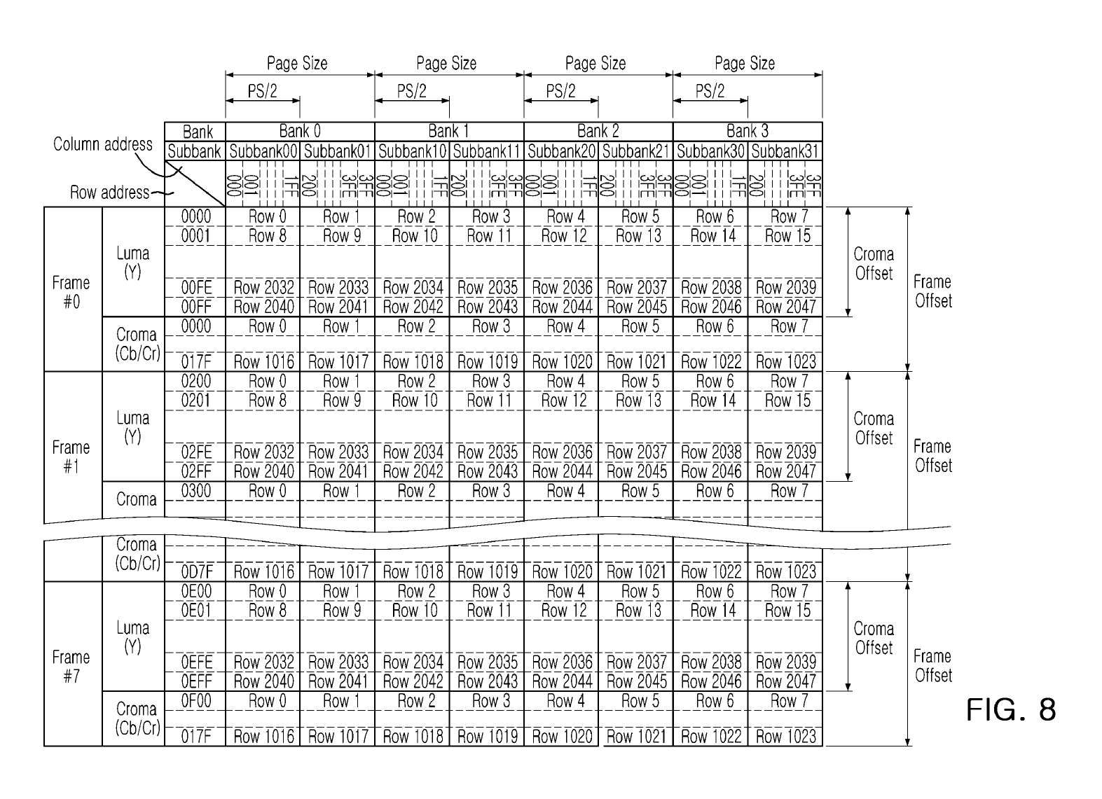

Namely, an optimized frame memory structure (image lines stored in a single page, a chrominance signal offset, a frame offset, a line distance, the maximum number of frames, etc.) as shown in FIG. 8 is generated according to memory configuration information (page size, bus width, bank number, row number) and image processing information (width and height of images). In this case, the frame offset and chrominance signal offset maybe automatically configured or may be inputted by a user.

The memory configuration information is inputted when the image processing device is initialized, and the image processing information may be extracted from a stream provided by the host system 200 when it is decoded, and may be extracted from an encoding parameter when it is encoded.

Each frame's configuration information is calculated according to Equation 1 and stored in an internal register, and the stored configuration information may be read from the exterior and used for memory accessing.

[Equation 1]

Image width=pixel width of a macroblock unit×16 1)

Image height=pixel height of a macroblock unit×16 2)

Frame access line distance=2^{(Ceil(log}^{₂}^{(image width)))} 3)

Field access line distance=frame access line distance×2 4)

Number of image lines per page=page size/frame access line distance 5)

Chroma signal offset=image height/image lines per page/number of banks 6)

Frame offset=chromaticity offset×3/2 7)

Maximum number of frames=floor(number of memory rows/frame offset) 8)

The ceil is a round-up value (i.e., the closest integer larger than or the same as this number), and the floor is a round-down value (i.e., the closest integer smaller than or the same as this number).

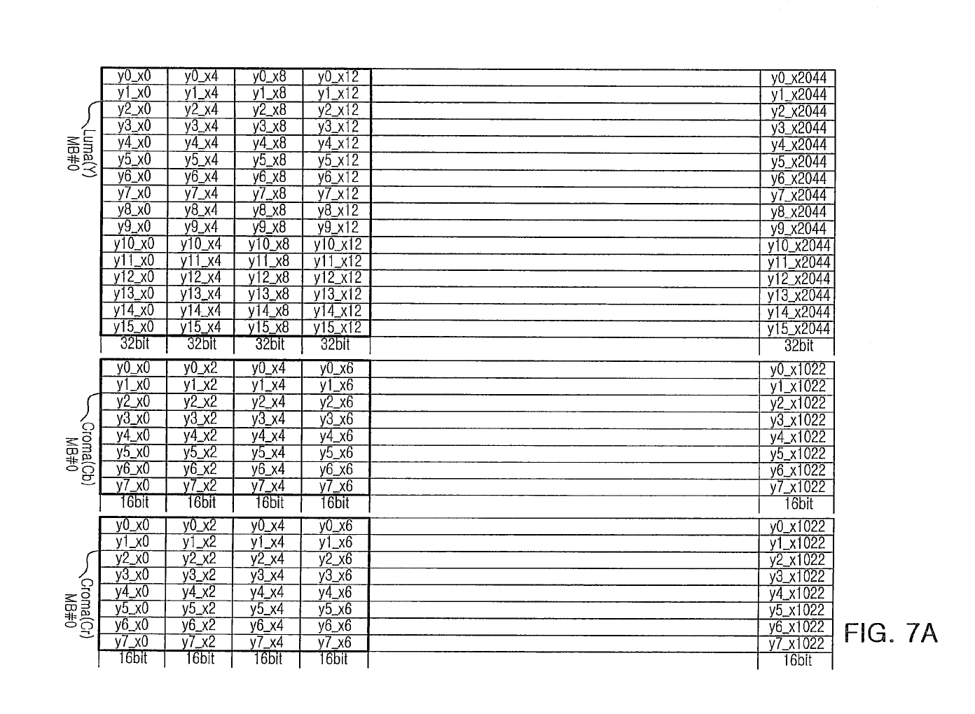

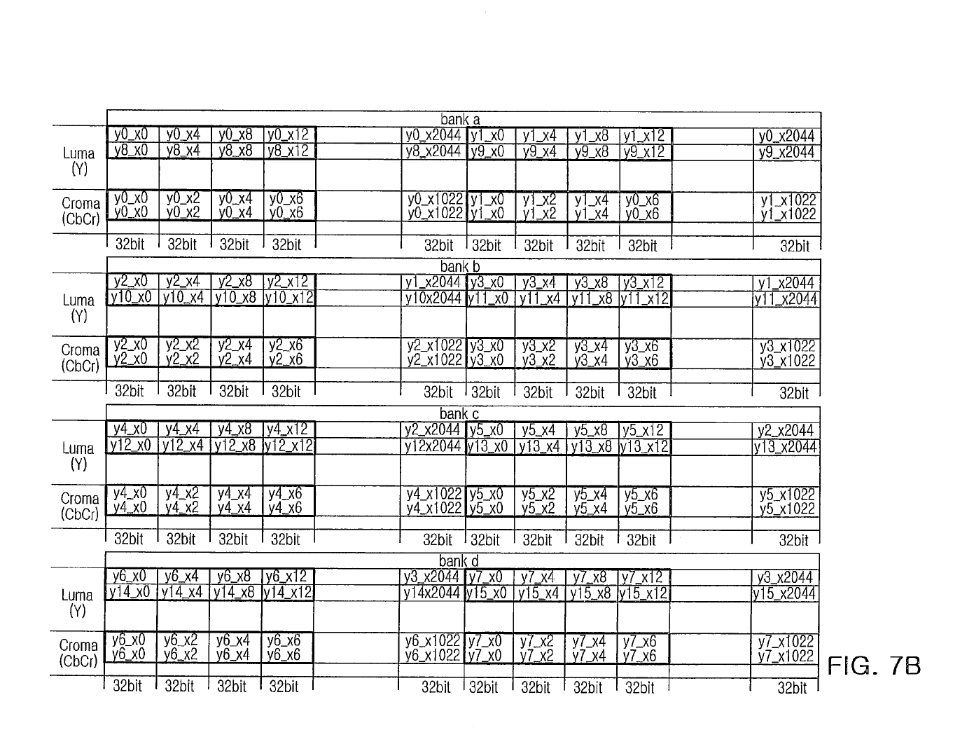

FIGS. 7A and 7B illustrate storage addresses and storage locations of macroblocks according to an exemplary embodiment of the present invention. Specifically, FIGS. 7A and 7B illustrate a frame memory implemented as a DRAM having a 32-bit interface and a 4096-byte page size.

In FIG. 7A, X coordinates and Y coordinates of No. 0 macroblock (MB#0) at a left upper end are shown, and only coordinates of a first pixel is illustrated under the assumption that one pixel has 8 bits so 16 bits include two pixels and 32 bits include four pixels.

Luma y0_x0 includes four luminance pixels of y=0, x=0, 1, 2, 3, and chroma y0_x0 includes two chrominance pixels of y=0 and x=0, 1.

The No. 0 macroblock (MB#0) having the storage addresses as shown in FIG. 7A is stored in a frame memory as shown in FIG. 7B.

With reference to FIG. 7B, when MB#0 is actually stored in the frame memory, its luma signal and chroma signal are separately stored, and the first chroma signal (Cb) and the second chroma signal (Cr) are interleaved by bytes and stored.

FIG. 8 illustrates a frame memory map according to an exemplary embodiment of the present invention. Specifically, FIG. 8 illustrates a frame memory map that uses 8 bits per pixel for luma and chroma signals and processes an image of 8 pages having a screen image size of 2048×2048 pixels based on luminance in case of using the DRAM having the page size of 4096 bytes (1024 words) and the interface of 32 bits (4 bytes) including 4096 pages.

The frame memory map is configured with reference to the above-described frame memory structure. Namely, the number of frames is determined according to the maximum number of frames calculated in recognizing the frame memory structure, a single bank is divided into a plurality of subbanks according to the number of image lines per page, and luma and chroma signals are separately stored according to a frame offset and a chroma signal offset.

For example, if the maximum number of frames in recognizing the frame memory structure is 8, the number of image lines per page is 2, a frame offset is 2n, and a chroma signal offset is calculated as 26′h0400000, then the frame memory map has such a form as shown in FIG. 8.

With reference to FIG. 8, the frame memory map includes eight frames, and each bank is divided into two subbanks according to image lines per page (namely, according to the page size and frame access line distance (LD) of the DRAM). The frame offset is designated to be 2n by {row address [11:0]), bank address [1:0], column address [9:0], byte address [1:0]}={12′h200,2′h0,10′h0,2′b00}=26′h0800000, and the chroma signal offset is designated as {row address [11:0]), bank address [1:0], column address [9:0], byte address [1:0]}={12′h100,2′h0,10′h0,2′b00}=26′h0400000.

In FIG. 8, one bank is divided into two subbanks and one line of an image are stored in one row of each subbank, two lines of the image is stored in one page of the DRAM and the banks are changed at every two lines.

The memory used in FIG. 8 is a virtual memory, and in the case of a low resolution image used for mobile purposes, the data of two or more lines may be stored in a single page by using a commercialized single memory having a page size of 1 KB. In case of an image of high resolution, a memory having a page size of 4 KB and an interface of 32 bits may be generated by combining four single memories, each having 8-bit interface and 1 KB page size, in parallel or combining two single memories, each having a 16-bit interface and 2 KB page size, in parallel. In addition, the data of two or more lines may be stored in a single page by using a module type memory.

In an exemplary embodiment of the present invention, frame/field accessing is performed to support interlace scanning by adjusting the line distance. When accessing is performed by frames, the line distance is a one-line size of an image, and when field accessing is performed, the line distance is a two-line size of an image.

In FIG. 8, in case of frame accessing, the line distance is 0x100 (512), and in case of field accessing, the line distance is 0x400 (1024).

When a single bank is divided into several subbanks to be used as shown in FIG. 8, because several image lines are continuously stored in a single bank, the number of times of changing rows can be reduced in accessing by blocks, reducing a delay time otherwise required for row changing, and also, in field accessing (0, 2, 4, 6, . . . , or 1, 3, 5, 7 . . . ), four banks are sequentially used each time rows are changed, increasing the efficiency of bank interleaving.

The addresses of the frame memory map configured as shown in FIG. 8 can be very simply computed through a bit unit combining method, and in this case, number notation (i.e., number declaration) follows a number notation format of Verilog HDL.

First, when the frame offset is 2n, an address at which a desired image signal is stored can be simply obtained through the bit unit combining according to Equation 2 shown below:

[Equation 2]

Luminance pixel address={frame index, luminance pixel, Y coordinate, X coordinate}={row address, bank address, column address, byte address} 1)

First chrominance pixel address={frame index, chrominance pixel, Y coordinate, X coordinate, chrominance pixel type}={row address, bank address, column address, byte address} 2)

Second chrominance pixel address=first chrominance pixel address+1 3)

When a pixel in which the X coordinate of a first frame is 32 and the Y coordinate of the first frame is 15 is taken as an example, a storage address of a luma signal is calculated to be 26′h0807820 as represented by Equation 3 shown below, and stored in a first byte of 208^{th} column (8^{th} in a subbank 31) of 201^{st} row of a third bank of the DRAM.

A first chroma signal is stored in a first byte of 208^{th} row (8^{th} in a subbank 31) of the 300^{th} row of the third bank of the DRAM, and a second chroma signal is stored in a second byte of the same position.

[Equation 3]

Frame index [2:0]=3′b001 1)

Y coordinate [10:0]=11′d15=11′h00F=11′b000_{—}0000_{—}1111 2)

X coordinate [10:0]=11′d32=11′h020=11′b000_0010_0000 3)

Luminance address={frame index [2:0], 1′b0, Y coordinate [10:0], X coordinate10:0]} (4)

={3′b001,1′b0,11′b000_{—}0000_{—}1111,11′b000_{—}0010_{—}00001}

=26′h0807820

={12′h201,2′h3,10h208,2′h0}

={row address [11:0], bank address [1:0], column address[9:0], byte address [1:0]}.

In this case, 1′b0 means a luma signal

First chrominance address={frame index [2:0], 2′b10, Y coordinate [10:1], X coordinate [10:1], 1′b0} 5)

={3′b001, 1′b10, 10′b000_{—}0000_{—}111, 9′b000_{—}0010_{—}000, 1′b0}

={12′h201, 2′h3, 10h208, 2′b00}

={row address [11:0]), bank address [1:0], column address [9:0], byte address[1:0]}

In this case, 2′b10 means a chroma signal, and 1′b0 means a first chroma signal.

Second chrominance address={frame index [2:0], 2′b10, Y coordinate [10:1], X coordinate [10:1], 1′b1} 6)

={3′b001, 1′b10, 10′b000_{—}0000_{—}111, 9′b000_{—}0010_{—}000, 1′b1}

={12′h201, 2′h3, 10h208, 2′b01}

={row address [11:0]), bank address[1:0], column address [9:0], byte address [1:0]}

=first chroma signal+1

In this case, 2′b10 means a chroma signal, and 1′b1 means a second chroma signal.

When the frame offset is 2n, an address at which a desired image signal is stored can be obtained by Equation 4 shown below:

[Equation 4]

Luminance address=frame index×frame offset+{Y coordinate, X coordinate} 1)

={row address, bank address, column address, byte address}

First chrominance address=frame index*frame offset+chrominance offset+{Y coordinate>>1, X coordinate>>1, 1′b0} 2)

={row address, bank address, column address, byte address}

In this case, 1′b0 means a first chroma signal.

Second chrominance address=frame index×frame offset+chrominance offset+{Y coordinate>>1, X coordinate>>1, 1′b1} 3)

={row address, bank address, column address, byte address}

=first chrominance address+1

In this case, 1′b1 means a second chroma signal.

In the above, (frame index×frame offset) may be substituted by (previous frame offset+frame offset) as in Equation 5 shown below, or a previously calculated value may be used.

[Equation 5]

frame 0 offset=frame buffer base address 1)

frame 1 offset=frame 0 offset+frame offset

. . .

frame n offset=frame n−1 offset+frame offset n)

In the configuration according to an exemplary embodiment of the present invention, although continuous data accessing is performed on different rows of the frame memory, data can be continuously access without delay for changing rows of the frame memory, except for an initial data delay.

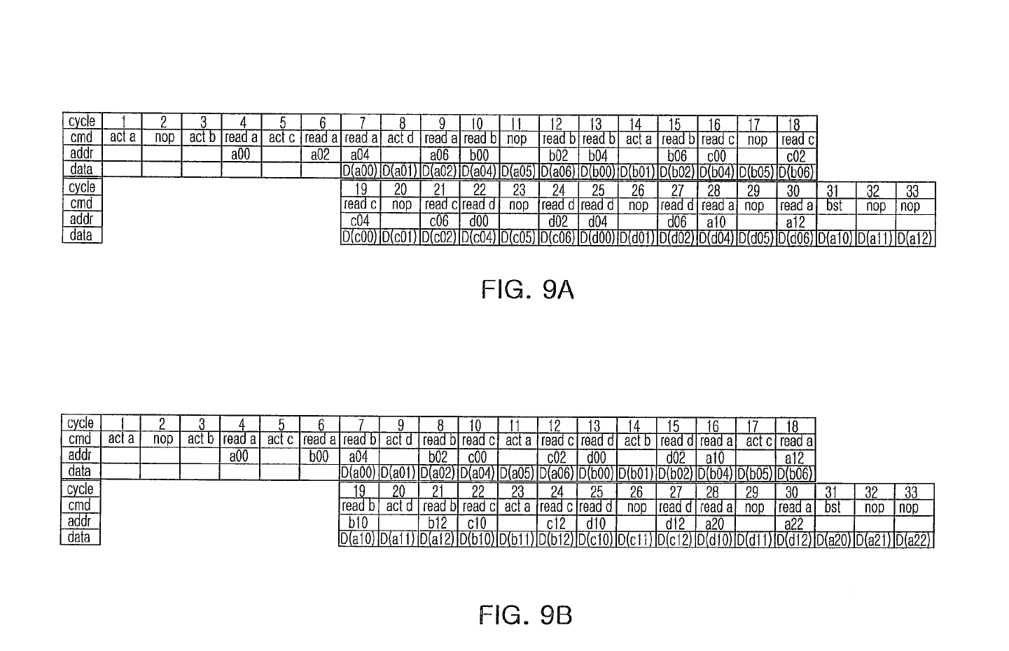

FIGS. 9A and 9B illustrate the cycles of transmitting 9×9 pixels including neighbor pixels for computing intermediate pixels for motion compensation with respect to luminance 4×4 blocks in H.264/AVC.

In FIGS. 9A and 9B, a delay time is calculated based on a timing of a DDR SDRAM having 16-bit interface, and it is assumed that a burst length is based on 4 and 32-bit (16 bits×2) data transmission is performed at a clock.

FIG. 9A illustrates 9 (3 words)×9 data transmission cycles for a motion compensation of Luma 4×4 in units of frames in the frame buffer structure. With reference to FIG. 9A, it is noted that image data of two lines are continuously read from one row, and the next line is read from a different bank, so delay is concealed in the previous memory accessing.

Accordingly, in order to read a total of 81 pixels, 27 data in units of words are required, and a total of 33 cycles obtained by adding 27 data cycles and the initial delay 6 cycles is required.

FIG. 9B illustrates 9 (three words)×9 data transmission cycles for a motion compensation of luma 4×4 in units of fields in the frame buffer structure. With reference to FIG. 9A, it is noted that banks are changed whenever lines are changed, and a total transmission cycles are 33 cycles, the same as the frame access cycles.

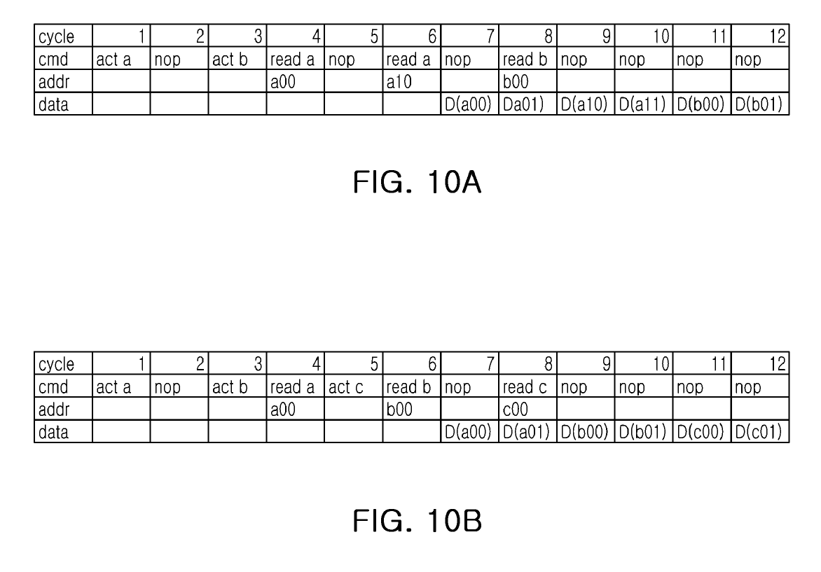

FIGS. 10A and 10B illustrate the cycles of transmitting 3×3 pixels including neighbor pixels for computing intermediate pixels for motion compensation with respect to chrominance 4×4 blocks in H.264/AVC.

Because the first and second chrominance pixels are stored in the same region as illustrated in FIG. 8, they can be simultaneously read through a single reading operation.

In case of frame accessing or field accessing, six cycles of the initial data delay and six cycles of the data transmission cycles are required, so the first and second chrominance pixels can be transmitted during a total of 12 cycles.

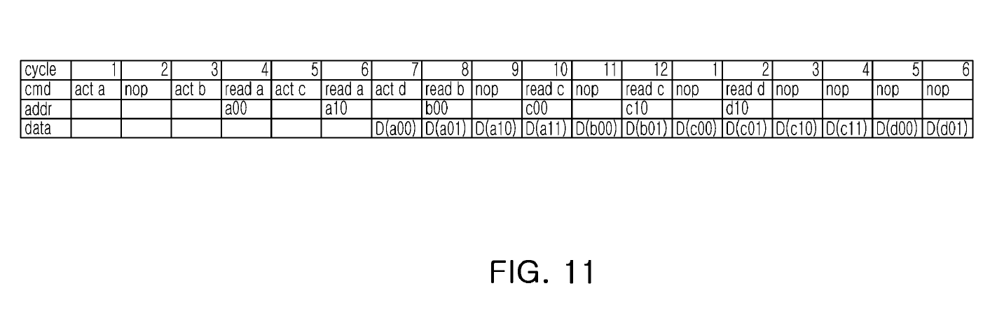

FIG. 11 illustrates concealment of initial delay six cycles generated during data transmission by previous data transmission cycles due to bank interleaving, when data blocks are continuously transmitted.

As shown in FIG. 11, when chroma signal blocks of 3×3 pixels are continuously transmitted, an initial delay is concealed at the second continuous data transmission and only six data transmission cycles are required.

As for motion compensation, when an extreme case that all 4×4 blocks of macroblocks are coded is taken as an example, in order to compensate motion with respect to a single macroblock, 16 times of luma 9×9 transmissions and 16 times of chroma 3×3 transmissions are continuously made.

In this case, as shown in Table 1 below, the initial delay cycles (6) plus 16 instances of luminance data transmission cycles (27) plus 16 instances of chrominance data transmission cycles (6), totaling 534 transmission cycles, are required.

As a result, the delay cycle accounts for merely 1.1 percent of the overall data transmission cycles, so 98.9 percent of the bandwidth provided by the memory can be used for actual data transmissions.

TABLE 1

| | Required cycle | Weight |
|---|---|---|
| Cycle type | (clock) | (percent) |
| Delay cycle | 6 | 1.1 |
| Data cycle | 16 × 27 + 16 × 6 = 528 | 98.9 |
| Total cycle | 6 + 528 | 100 |

The above-described functions are all performed by the memory controller 180 provided in the image processing device in FIG. 3, so the frame memory-related functions, which are distributedly (separately) managed in the related art, can be collectively and integrally managed. In this case, as discussed above, the frame memory-related functions are collectively and integrally managed through only some parameter, the frame memory-related functions can be more simply performed.

As set forth above, the image processing apparatus and the frame memory management method for image processing according to exemplary embodiments of the invention have the advantages in that, in accessing the frame memory, a data realignment for a display screen is not required, an address computation in accessing the frame memory by blocks is simple, the memory structure is intuitive, and frame data can be successively accessed by blocks without delay.

In addition, when the frame memory in a single frame memory structure is accessed, frames/fields can be selectively accessed by macroblocks by correcting a line distance, effectively supporting the interlace scanning.

Also, a frame memory structure appropriate for a configuration can be automatically generated with reference to the image processing apparatus and external memory settings.

Moreover, frame memory-related functions, which are generally distributed to be managed, can be integrated to be managed more simply and effectively.

While the present application has been shown and described in connection with the exemplary embodiments, it will be apparent to those skilled in the art that modifications and variations can be made without departing from the spirit and scope of the invention as defined by the appended claims.

What is claimed is:

1. A method for managing a frame memory, the method comprising:
determining a frame memory structure with reference to memory configuration information and image processing information;
configuring a frame memory such that a plurality of image signals are stored in each page according to the frame memory structure; and
computing signal storage addresses by combining image acquiring information by bits, and accessing a frame memory map to write or read an image signal by pages.

2. The method of claim 1, wherein, in determining the frame memory structure, the maximum number of frames of the frame memory, the number of image lines per page, a frame offset, and a chrominance signal offset are determined with reference to the memory configuration information including information about a page size, a bus width, the number of banks, and the number or rows, and the image processing information including information about a width and height of an image.

3. The method of claim 2, wherein, in determining the frame memory structure, the maximum number of frames and the number of image lines per page are determined by equations shown below:
Image width=pixel width of a macroblock unit×16 1)
Image height=pixel height of a macroblock unit×16 2)
Frame access line distance=2^{(Ceil(log}^{₂}^{(image width)))} 3)
Field access line distance=frame access line distance×2 4)
Number of image lines per page=page size/frame access line distance 5)
Maximum number of frames=floor(number of memory rows/frame offset) 6)
wherein ceil a round-up value and the floor is a round-down value.

4. The method of claim 2, wherein, in determining the frame memory structure, the frame offset and the chrominance signal offset are determined according to equation shown below or is inputted by a user:
chrominance signal offset=image height/image lines per page/number of banks, (1)
frame offset=chrominance offset×3/2. (2)

5. The method of claim 2, wherein, in configuring the frame memory, the number of frames is determined according to the maximum number of frames, a single bank is divided into a plurality of subbanks according to the number of image lines per page, and a luminance signal and a chrominance signal are separately stored according to the frame offset and the chrominance signal offset.

6. The method of claim 5, wherein, in configuring the frame memory, when an image signal includes a luminance signal and first and second chrominance signals, a start address of rows for storing the luminance signal is determined according to the frame offset, and a start address of rows for storing the first and second chrominance signals is determined according to the frame offset and the chrominance signal offset.

7. The method of claim 5, wherein, in configuring the frame memory, when an image signal includes a luminance signal and first and second chrominance signals, a plurality of luminance signals or the first and second chrominance signals are stored together in a single page.

8. The method of claim 1, wherein, in writing and reading, when an image signal includes a luminance signal and first and second chrominance signals and a frame offset is 2n, a luminance signal address and first and second chrominance signal addresses are acquired from image acquisition information including a frame index, a signal type, and x and Y coordinates according to equations shown below:
a luminance pixel address={frame index,luminance pixel, Y coordinate, X coordinate}={row address, bank address, column address, byte address}, 1)
first chrominance pixel address={frame index, chrominance pixel, Y coordinate, X coordinate, a chrominance pixel type}={row address, bank address, column address, byte address}, and 2)
second chrominance pixel address=first chrominance pixel address+1. 3)

9. The method of claim 1, in writing and reading, when an image signal includes a luminance signal and first and second chrominance signals and a frame offset is not 2n, a luminance signal address and first and second chrominance signal addresses are acquired from image acquisition information including a frame index, a signal type, and x and Y coordinates, according to equations shown below:
a luminance pixel address=frame index×frame offset+{Y coordinate, X coordinate}={row address, bank address, column address, byte address}, 1)
first chrominance pixel address=frame index×frame offset+chrominance offset+{Y coordinate>>1, X coordinate>>1, a chrominance pixel type}={row address, bank address, column address, byte address}, and 2)
second chrominance pixel address=first chrominance pixel address+1. 3)

10. The method of claim 1, wherein, in writing and reading, accessing is performed in a bank interleaving manner, and in this case, an access unit is changed by correcting a line distance.

11. The method of claim 10, wherein, in writing and reading, a field access line distance is double a frame access line distance.

12. An apparatus for managing a frame memory, the apparatus comprising:
a stream controller that interprets an image data stream provided from a host system;
a stream processing unit that reads an image signal of a region corresponding to a motion vector provided from the stream controller, from a frame memory to configure a motion compensation screen image, and configures a predicted screen image and a residual screen image based on data provided from the stream controller;
a screen image reconfiguring unit that configures an original screen image by adding the predicted screen image or the motion compensation screen image and the residual screen image in a screen image;
a deblocking filter that reads a screen image of a neighbor block from the frame memory, filters the read screen image together with the original screen image, and restores the same in the frame memory; and
a frame memory controller that provides control to simultaneously store a plurality of image signals in each page of the frame memory, and acquires a signal storage address from image acquisition information through a bit unit combining method and accesses the frame memory to write or read an image signal by pages when the stream processing unit or the deblocking filter requests accessing.

13. The apparatus of claim 12, wherein the frame memory controller determines the maximum number of frames of the frame memory, the number of image lines per page, a frame offset, and a chrominance signal offset with reference to the memory configuration information including information about a page size, a bus width, the number of banks, and the number or rows, and the image processing information including information about a width and height of an image.

14. The apparatus of claim 13, wherein the frame memory controller determines the number of frames according to the maximum number of frames, divides a single bank into a plurality of subbanks according to the number of image lines per page, and separately stores a luminance signal and a chrominance signal according to a frame offset and a chrominance signal offset.

15. The apparatus of claim 13, wherein when an image signal includes a luminance signal and first and second chrominance signals and a frame offset is 2n, the frame memory controller acquires a luminance signal address and first and second chrominance signal addresses from image acquisition information including a frame index, a signal type, and x and Y coordinates, according to the following equations:
a luminance pixel address={frame index, luminance pixel, Y coordinate, X coordinate}={row address, bank address, column address, byte address}, 1)
first chrominance pixel address={frame index, chrominance pixel, Y coordinate, X coordinate, a chrominance pixel type}={row address, bank address, column address, byte address}, and 2)
second chrominance pixel address=first chrominance pixel address+1. 3)

16. The apparatus of claim 13, when an image signal includes a luminance signal and first and second chrominance signals and a frame offset is not 2n, the frame memory controller acquires a luminance signal address and first and second chrominance signal addresses from image acquisition information including a frame index, a signal type, and x and Y coordinates, according to the following equations:
a luminance pixel address=frame index×frame offset+{Y coordinate, X coordinate}={row address, bank address, column address, byte address}, 1)
first chrominance pixel address=frame index×frame offset+chrominance offset+{Y coordinate>>1, X coordinate>>1, a chrominance pixel type}={row address, bank address, column address, byte address}, and 2)
second chrominance pixel address=first chrominance pixel address+1. 3)

17. The apparatus of claim 13, wherein the frame memory controller performs accessing in a bank interleaving manner, and in this case, an access unit is changed by correcting a line distance.

18. The apparatus of claim 17, wherein a field access line distance is double a frame access line distance.
